(19) United States
(12) Patent Application Publication
(10) Pub. No.: US 2021/0192646 A1
(43) Pub. Date: Jun. 24, 2021

(54) CONSTRUCTION SITE MANAGEMENT OPTIMIZATION

(71) Applicant: GTT Informed Construction Decisions Inc., London (CA)

(72) Inventors: Gideon Avigad, London (CA); Tamir Cohen, London (CA); Toni Lupu, London (CA); Marc Milton, London (CA)

(21) Appl. No.: 16/723,553

(22) Filed: Dec. 20, 2019

(51) Int. Cl. G06Q 50/08; G06N 5/04; G06Q 10/06

(52) U.S. Cl. CPC G06Q 50/08; G06Q 10/06313; G06N 5/04

(57) ABSTRACT

A method to manage a construction site by acquiring data about the construction site actual production, actual productivity and actual material deployment using RFID technology and vision systems. The method evaluates the difference between said actual production, actual productivity and actual material deployment and a planned productivity, a planned production and a planned material deployment to recommend changes to improve said planned productivity, planned production and planned material deployment. It also keeps record of all of the above for dispute resolution.

### FIELD OF THE INVENTION

The present disclosure relates to a method for managing a construction site.

### BACKGROUND

Construction site management is very complex and requires skillful site managers capable of making many decisions that have significant impact on productivity and progress of the construction project. There is a need for a method and system to assist site managers in making efficient decisions.

### BRIEF SUMMARY

It is the object of the present invention to provide a construction site management system.

In accordance with an aspect of the invention, there is provided a method to manage a construction site by acquiring data about the construction site actual production, actual productivity and actual material deployment using RFID technology and vision systems. The method evaluates the difference between said actual production, actual productivity and actual material deployment and a planned productivity, a planned production and a planned material deployment to recommend changes to improve the planned productivity, planned production and planned material deployment.

In accordance with an embodiment of the invention, a method to manage a construction site further comprising the keeping of a historical record of the actual production, actual productivity and actual material deployment and a planned productivity, a planned production and a planned material deployment.

In accordance with an embodiment of the invention, a method to manage a construction site further comprising recommending changes to one or more of the planned productivity, the planned production and the planned material deployment.

In accordance with an embodiment of the invention, a method to manage a construction site further comprising optimizing the recommending using stochastic optimization techniques.

In accordance with an embodiment of the invention, a method to manage a construction site further comprising developing correlations to enhance accuracy of the optimization.

In accordance with an embodiment of the invention, the vision systems comprise cameras affixed on one or more robots.

In accordance with an embodiment of the invention, the vision systems comprise cameras set up at fixed locations.

In accordance with an embodiment of the invention, the robots are autonomous.

In accordance with an embodiment of the invention, the robots are remote controlled.

In accordance with an embodiment of the invention, the vision systems comprise cameras carried by humans.

In accordance with an embodiment of the invention, the camera is a 3D camera.

### BRIEF DESCRIPTION OF THE SEVERAL VIEWS OF THE DRAWINGS

FIG. 1 illustrates a construction site management system in accordance with the prior art.

FIG. 2 illustrates an enhanced construction site management system in accordance with one embodiment.

FIG. 3 illustrates an embodiment with the decision making being responsibility of an analyst.

FIG. 4 illustrates an embodiment where the decision making is assisted with optimization and correlation software.

### DETAILED DESCRIPTION

The details of one or more embodiments of the subject matter of this specification are set forth in the accompanying drawings and the description below. Other features, aspects, and advantages of the subject matter will become apparent from the description, the drawings, and the claims.

Like reference numbers and designations in the various drawings indicate like elements.

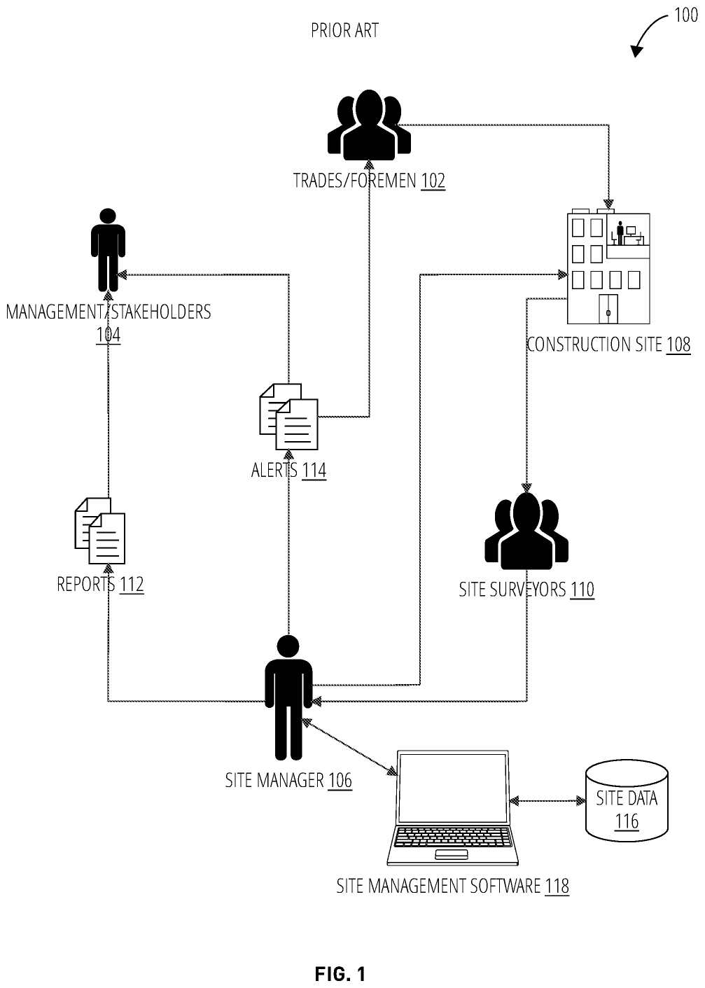

FIG. 1 depicts a typical construction site 108 management system 100 as per existing art.

Construction designers perform a set-up through using different site management software 118 to derive site data 116. The site management software may include (but not limited to) capability to develop one or more of building information model (BIM), partition work area in site area units (SAU), calculate Bill of Quantity (BOQ), estimate bill of quantities (BOQ) for the entire site or per SAU, estimate the number of work hours per trade (and optionally per SAU), estimate the work progress and the deployment of materials. The site data 116 will therefore include a scheduled plan for using workers from each trade (potentially per SAU), termed here as productivity, a scheduled plan for work progress (potentially per SAU), termed here as production and a scheduled plan for deploying the BOQ (potentially per SAU), referred to herein as material deployment. The site manager 106 can access any site data 116 via software executed on a computer 118 in any format to manage the construction site 108.

The site manager 106 prepares reports 112 and alerts 114 for the higher management and/or stakeholders 104 to inform on status and changes. Similar or different alerts 114 are sent to the trades and foremen 102 to apply changes to the construction site 108. The site manager 106 receives input from site surveyors 110 who are onsite at the construction site 108. The input received includes actual productivity, actual production and actual material deployment i.e., number of workers form each trade working on site, what is the work progress, and what material has been deployed and where, respectively.

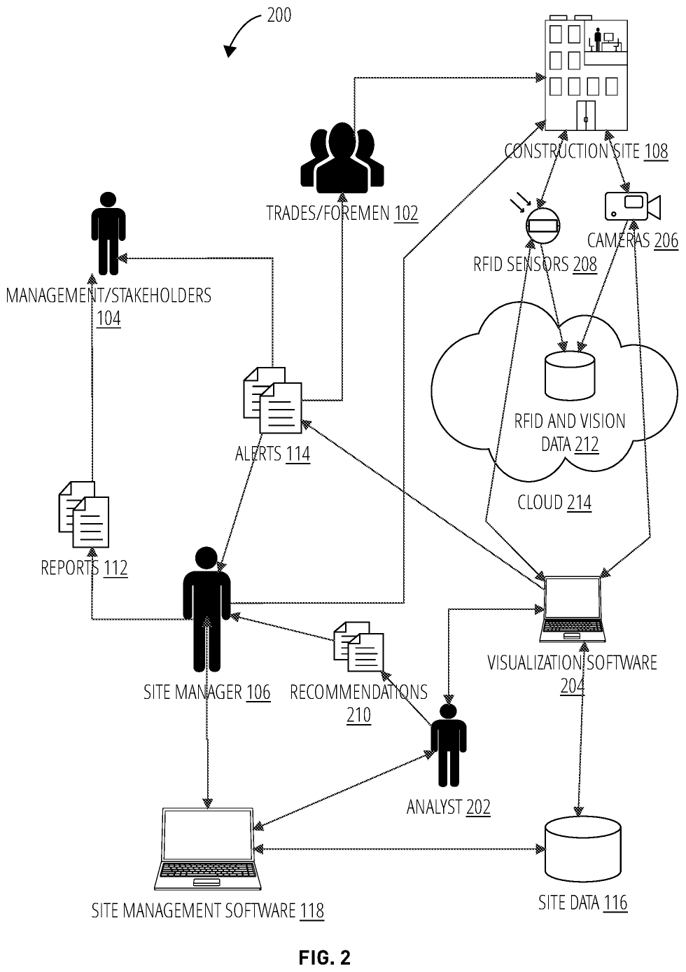

FIG. 2 depicts one embodiment 200, where active RFID sensors 208 and cameras 206 are used to capture data on the construction site 108. The RFID sensors 208 can be located on the trades and/or foremen 102. The RFID sensors 208 can also be attached to material and equipment. Cameras 206 can be fixed or mobile using remotely driven and/or autonomous robots or drones and in challenging accessibility places, carried by humans. Cameras 206 can have the ability to take 3D videos, 3D point cloud data and/or provide 360-degree views.

For estimating the actual production, the mobile robot is moving along a predefined path that can be taught through walking the robot through the path using a control pad. The path can then be followed using dead reckoning (encoders known in the art) and/or triangulation by using an indoor navigation system known in the art. Obstacle avoidance, as known in the art, may be implemented as well. The robot is preferably narrow enough to allow moving into rooms and in narrow corridors. In another embodiment, the robot can be remotely controlled by the analyst 202. The robot has preferably a capability of climbing stairs so as to reach higher floors. The robot can be charged in a specially designed charging station. The transfer of RFID and vision data 212 to a storage in the cloud 214, or directly to a remote computer or server, can be done daily, or whenever needed, during charging by connecting directly to the network. Alternatively, wireless or 5G technology may be used to transfer the captured data. The robot can be equipped with 3D Camera and 3D laser as known in the art to allow capturing visual and spatial data respectively.

In another embodiment, stationary cameras and or a combination of robot-carried and stationary cameras may be used. In another embodiment drones may carry the needed sensors (for example 3D sensors). In another embodiment humans may carry the sensors. The locations at which visual data can be captured is predefined during the set-up stage, however these may be reallocated as requirements for new positions may be requested by the analyst. For each location the robot can save its location (dead reckoning, global positioning etc.) with the captured vision data.

The RFID sensors 208 used on the workers allow to know where they are, and how long they spend in a specific location or SAU and therefore to estimate the actual productivity.

The RFID system is used to constantly capture data on where is each worker (data including trade, experience, past productivity etc.) is located within the specific building, level, SAU. The RFID may optionally be combined with facial recognition as known in the art. In another embodiment other worker identification maybe used e.g., facial recognition.

For actual material deployment, RFIDs may be mounted on the deployed materials and used to track the material.

An analyst 202, working potentially from a remote office or control room, receives real-time or near-real-time data on actual productivity (labor allocation), actual production (work progress) and actual location of all materials; actual material deployment in the construction site 108 based on the data gathered by the RFID sensors 208 and the cameras 206. The site management software 118 along with the site data 116 and a visualization software 204 are available to the analyst 202 to make recommendations 210 to the site manager 106 such as on re-scheduling, re-planning, re-allocation of human resources and or materials. The site manager can make decisions on re-scheduling, re-planning, re-allocation of human resources or materials based on the recommendations 210. The analyst 202 can serve one or more construction sites. In one embodiment, the analyst makes recommendations based on their experience and knowledge using visualization software by considering the RFID information and camera-related information.

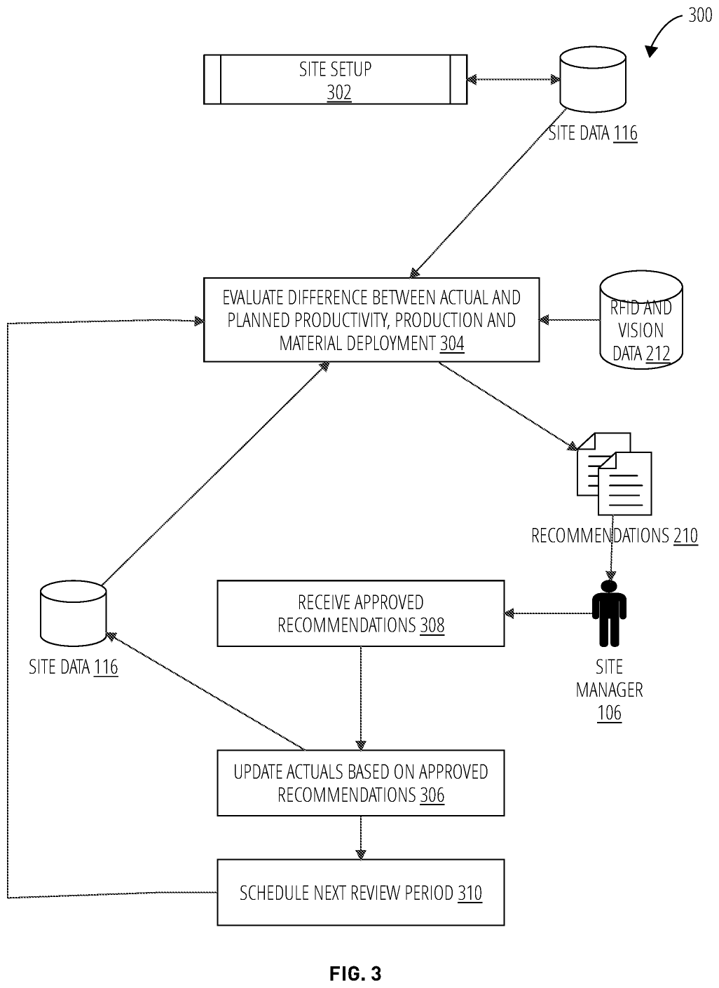

FIG. 3 depicts a workflow for the analyst 202 according to the above embodiment. The site setup 302 is performed using a variety of site management software 118 to create site data 116. The site data includes a plan for use of workers (productivity), a plan for work progress (production) and a plan for material deployment.

When reviewing the site progress, the analyst 202 considers actual productivity 208 captured by the RFIDs, actual production 206, using vision data, and actual material deployment as received from the RFIDs 208. The analyst 202 evaluates differences between actual and planned productivity, production and material deployment 304 to devise recommendations 210 to be sent to the site manager 106.

When the site manager 106 approves the recommendations 210, the updated planned productivity, planned production and planned material deployment are updated in the site data 116 and another review period is scheduled either at fixed time period or when needed.

For each scheduled review period, the history of the actual and planned data for production, productivity and material deployment is saved and is associated with the schedule they were taken. This serves as documentation control and used for forensic analysis in case of a dispute.

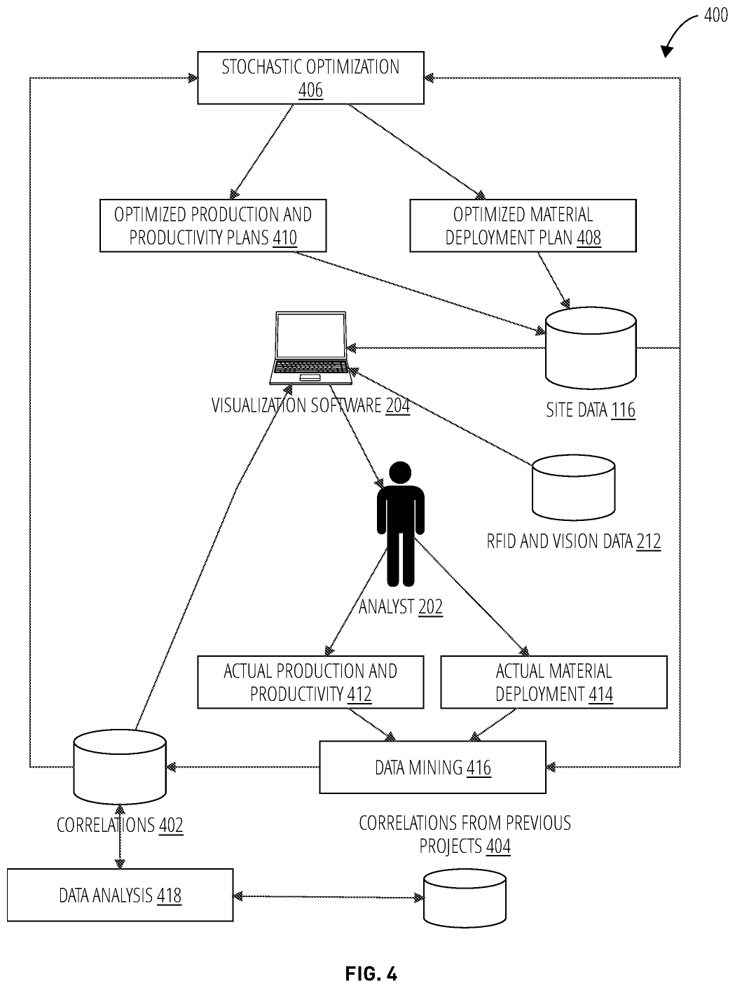

FIG. 4 depicts another embodiment 400 where optimization software can be used in addition to the analyst 202 or solely to improve the recommendations. The optimization software may include a stochastic optimization 406 to calculate an optimized production and productivity plans 410 as well as optimized material deployment plan 408. Any multi-objective stochastic optimization algorithm known in the art can be used to assist in optimizing the recommendations. In another embodiment a utility based single-objective stochastic optimization, as known in the art, can serve for that. The optimized plans are used to update the site data 116 and the models used in the site management software 118 in order to get implemented and serve for the next round. The optimization's objectives may include but not limited to minimal construction time, minimal cost and minimal risk.

The analyst 202 evaluates the actual production and actual productivity 412 as well as actual material deployment 414 used based on the RFID and vision data 212 comparing to existing site data 116. The analyst may also use for the comparison an automated comparison between as-built spatial data (actual production) and production plans, as known in the art. Alternatively, or in addition, visual inspection of 360 data may be used to assess the progress.

The current site data 116 and actual data 412, 414 are fed to a data mining 416 system that establishes correlations 402 among the data points. Optionally correlations from one or more correlations from previous projects 404 can be used to augment the data source and improve on the correlations 402. The up to date correlations 402 are fed into the stochastic optimization 406 software to improve the recommendations. In another embodiment these or other correlations may be directly reported to the analyst for making recommendations.

In another embodiment, the analyst manual evaluation may serve as one of the inputs to the data-mining-based correlation building. Collecting and utilizing data (for example on teams, workers, environmental conditions, projects) and their effect on actual production and actual productivity for building such correlations, enhances accuracy of the recommendations. The optimization may relate the number of workers with actual production and actual productivity data to come up with the optimized recommendations (updated planed productivity, production and material deployment)

In another embodiment, recommendations made by the analyst as well as decisions made by the site manager can be stored and learned over time and relations among inputs (current resources, production etc.) and outputs (decisions on resource allocation etc.) may be modeled (e.g., using a neural network) to improve on the optimization.

The foregoing descriptions of specific embodiments of the present invention have been presented for purposes of illustration and description. They are not intended to be exhaustive or to limit the invention and method of use to the precise forms disclosed. Obviously, many modifications and variations are possible in light of the above teaching. The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient but is intended to cover the application or implementation without departing from the spirit or scope of the claims of the present invention.

What is claimed is:

1. A method to manage a construction site comprising:
acquiring data about the construction site actual production, actual productivity and actual material deployment using RFID technology and vision systems;
evaluating the difference between said actual production, actual productivity and actual material deployment and a planned productivity, a planned production and a planned material deployment to recommend changes to improve said planned productivity, planned production and planned material deployment.

2. The method of claim 1 further comprising of keeping a historical record of said actual production, actual productivity and actual material deployment and a planned productivity, a planned production and a planned material deployment.

3. The method of claim 1 further comprising recommending changes to one or more of the said planned productivity, said planned production and said planned material deployment.

4. The method of claim 1 further comprising optimizing said recommending using stochastic optimization techniques.

5. The method of claim 1 further comprising developing correlations to enhance accuracy said optimization.

6. The method of claim 1 wherein said vision systems comprise cameras affixed on one or more robots.

7. The method of claim 1 wherein said vision systems comprise cameras carried by humans.

8. The method of claim 6 wherein said robots are autonomous.

9. The method of claim 6 wherein said robots are manually remote controlled.

10. The method of claim 1 wherein said vision systems comprise cameras set up at fixed locations.

11. The method of claim 6 wherein said camera is a 3D camera.

12. The method of claim 1 further comprising keeping a record for dispute resolution.
